(19) United States
(12) Patent Application Publication
(10) Pub. No.: US 2022/0242518 A1
(43) Pub. Date: Aug. 4, 2022

(54) FRONT FORK

(71) Applicant: KYB MOTORCYCLE SUSPENSION CO., LTD., Gifu (JP)

(72) Inventor: Soudai SHIMAUCHI, Gifu (JP)

(73) Assignee: KYB MOTORCYCLE SUSPENSION CO., LTD., Gifu (JP)

(21) Appl. No.: 17/626,695

(22) PCT Filed: Jul. 20, 2020
(86) PCT No.: PCT/JP2020/028060

§ 371 Date: Jan. 12, 2022

(30) Foreign Application Priority Data
Aug. 5, 2019 (JP) 2019-143773

(51) Int. Cl. B62K 25/08; F16F 9/34

(52) U.S. Cl. CPC B62K 25/08; F16F 9/46; F16F 9/34

(57) ABSTRACT

In order to achieve the above object, a front fork in means for solving the problem of the present invention includes: a telescopic fork main body that includes a vehicle body side tube and an axle side tube and is capable of extending and contracting; a cap that is attached to a vehicle body side end of the vehicle body side tube; a cylinder that is provided in the axle side tube; a tubular rod that is inserted into the cylinder so as to be axially movable and has one end connected to the cap; an electric device that is accommodated in the cylinder; a terminal that is provided in the cap; and a connector that is provided partway in a wiring connected to the terminal and the electric device and capable of electrically connecting and disconnecting the terminal and the electric device.

### TECHNICAL FIELD

The present invention relates to a front fork.

### BACKGROUND ART

In the related art, as a front fork that supports a front steered wheel of a straddle vehicle, for example, a telescopic front fork is known, which includes: a fork main body including a vehicle body side tube and an axle side tube movably inserted into the vehicle body side tube; and a damper accommodated in the fork main body, and extending and contracting in accordance with extension and contraction of the fork main body.

The damper includes a cylinder, a piston that partitions an inside of the cylinder into an extension side chamber and a compression side chamber which are filled with a hydraulic liquid, and a piston rod that is inserted into the cylinder so as to be axially movable and is connected to the piston. In the damper, for example, the piston rod is connected to a cap that closes an upper end of the vehicle body side tube, and the cylinder is fixed to a lower end of the axle side tube and accommodated in the fork main body.

In such a front fork, damping force generated by the damper for improving riding comfort of the straddle vehicle can be adjusted by a controller installed outside the front fork. In the front fork capable of automatically adjusting the damping force, for example, electroviscous fluid or electromagnetic viscous fluid is used as the hydraulic liquid of the damper, and the damping force is changed by adjusting an amount of a current supplied to a coil accommodated in the piston to change viscosity of the hydraulic liquid (refer to, for example, Patent Literature 1). Furthermore, in another front fork capable of automatically adjusting the damping force, a solenoid valve is accommodated in the piston and the damping force of the damper is adjusted by adjusting an amount of current to the solenoid valve.

### CITATION LIST

### Patent Literature

Patent Literature 1: JP 2014-190405 A

### SUMMARY OF INVENTION

### Technical Problem

In the front fork capable of automatically adjusting the damping force as described above, an electric device such as a coil or a solenoid valve for adjusting the damping force is provided in the damper, and it is necessary to supply power from an external power supply or a controller to the electric device. Therefore, in the front fork or the related art, the piston rod is formed in a tubular shape, a through hole through which a wiring passes is provided in a cap, the wiring is lead out to the outside of the fork main body through the inside of the piston rod and the Through hole of the cap while the wiring connected to the electric device is sealed, and the wiring is connected to the external power supply or the like.

However, in the front fork of the related art, in a case where the front fork is disassembled for maintenance of replacing a seal, a spring, and the like, the wiring cannot be removed from the cap, and maintenance work is very difficult. Furthermore, even in a case where the cap is provided with a connector that enables connection and disconnection between the external power supply and the electric device, it is necessary to remove the wiring extending from the electric device from a terminal in the connector in order to remove the cap. Therefore, it is not easy to perform the maintenance work simply by providing the connector to the cap. Furthermore, the problem described above is a problem that occurs commonly in a front fork that accommodates an electric device such as a stroke sensor in the fork main body other than the coil and the solenoid valve.

Therefore, an object of the present invention is to provide a front fork that facilitates the maintenance work even when the electric device is provided therein.

### Solution to Problem

In order to achieve the above object, a front fork in means for solving the problem of the present invention includes: a telescopic fork main body that includes a vehicle body side tube and an axle side tube, and is capable of extending and contracting; a cap that is attached to a vehicle body side end of the vehicle body side tube; a cylinder that is provided in the axle side tube; a tubular rod that is inserted into the cylinder so as to be axially movable and has one end connected to the cap; an electric device that is accommodated in the cylinder; a terminal that is provided in the cap; and a connector that is provided partway in a wiring connected to the terminal and the electric device and capable of electrically connecting and disconnecting the terminal and the electric device. In the front fork configured in this manner, the terminal and the electric device are separated from partway in the wiring by the connector, and the cap can be easily and completely removed from the vehicle body side tube to open an upper end opening portion of the vehicle body side tube without being hindered by the wiring.

Furthermore, the cap may have an annular shape and include the socket that is detachably attached to the inner circumference of the cap and holds the terminal, and the connector may be capable of passing through the inner circumference of the cap. In the front fork configured in this manner, the socket is removed from the cap without removing the cap from the vehicle body side tube, the connector is taken out from the fork main body, the connector is separated, and thus the wiring can be separated into a device side wiring and a terminal side wiring. Furthermore, in The front fork configured in this manner, since the wiring can be separated into the device side wiring and the terminal side wiring without twisting the wiring, disconnection and deterioration of the wiring can be suppressed. Moreover, since the socket and the terminal side wiring can be removed from the cap, the work of removing the cap from the vehicle body side tube is also easily performed.

Moreover, the cap has an annular shape and includes the socket that is detachably attached to the inner circumference of the cap and holds the terminal, the connector is capable of passing through the inner circumference of the cap, the socket includes the base portion inserted into the inner circumference of the cap, and the base portion includes the claw that can be inserted into a groove formed in the inner circumference of the cap. In the front fork configured in this manner, an operation of rotating the socket with respect to the cap is not Performed in the attachment and detachment work of the socket with respect to the cap, and the wiring is not twisted. Therefore, disconnection and fatigue of the wiring can be prevented. Furthermore, in the front fork configured in this manner, since the socket and the cap are not increased in size as compared with the case where the socket is fixed to The cap by the screw, it is possible to prevent the front fork from being increased in size.

The front fork includes a rotation stopper that prevents the rotation in the circumferential direction while allowing a relative movement between the socket and the cap in the axial direction. In the front fork configured in this manner, since the socket does not rotate in the circumferential direction with respect to the cap and does not twist the wiring, disconnection and deterioration of the wiring can be prevented when the front fork is used.

Furthermore, the rotation stopper includes a key that is provided on the outer circumference of the socket and a key groove that is provided on the inner circumference of the cap and into which the key is inserted, and the rotation stopper is installed at two or three places at equal intervals in the circumferential direction of the socket and the cap. In the front fork configured in this manner, the socket can be attached to the cap in two or three different attachment orientations in the circumferential direction, and a plug on the external power supply side can be reliably connected to a socket portion while avoiding interference between the socket portion and a handle regardless of types of the straddle vehicles.

### Advantageous Effects of Invention

Therefore, in the front fork of the present invention, the maintenance work is easily performed even when the electric device is provided therein.

### BRIEF DESCRIPTION OF DRAWINGS

FIG. 1 is a longitudinal sectional view of a front fork according to an embodiment of the present invention.

FIG. 2 is an enlarged longitudinal sectional view of an upper end portion of a front fork according to an embodiment of the present invention.

FIG. 3 is an enlarged plan view of a socket of a front fork according to an embodiment of the present invention.

### DESCRIPTION OF EMBODIMENTS

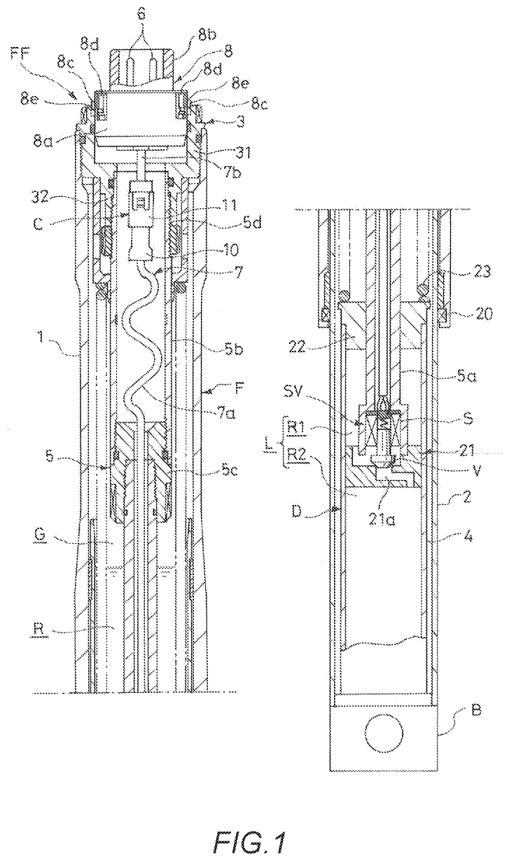

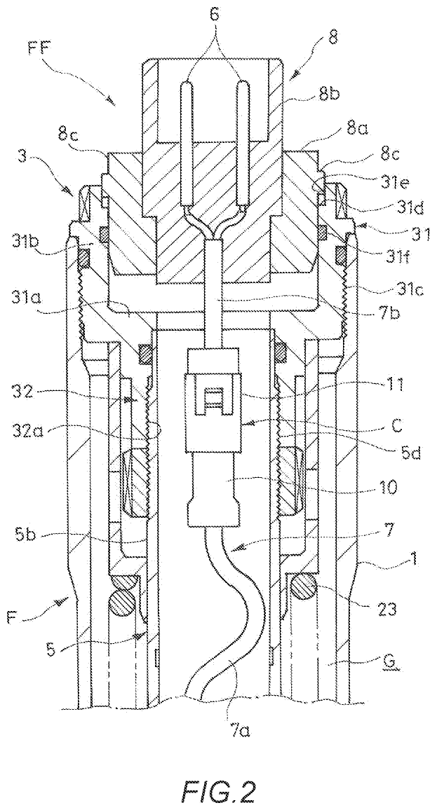

Hereinafter, the present invention will be described based on the embodiments illustrated in the drawings. As illustrated in FIG. 1, a front fork FF according to an embodiment includes: as illustrated in FIGS. 1 and 2, a telescopic fork main body F that includes a vehicle body side tube 1 and an axle side tube 2, and is capable of extending and contracting; a cap 3 that is attached to a vehicle body side end of the vehicle body side tube 1; a cylinder 4 that is provided in the axle side tube 2; a piston rod 5, as a tubular rod, which is inserted into the cylinder 4 so as to be axially movable and has one end connected to the cap 3; a solenoid S, as an electric device, which is accommodated in the cylinder 4; a terminal 6 that is provided in the cap 3; and a connector C that is provided partway in a wiring 7 connected to the terminal 6 and the solenoid S and capable of electrically connecting and disconnecting the terminal 6 and the solenoid S.

Hereinafter, each unit of the front fork FF according to the embodiment will be described in detail. As illustrated in FIGS. 1 and 2, the front fork FF includes the telescopic fork main body F including the vehicle body side tube 1 and the axle side tube 2 slidably inserted into the vehicle body side tube 1. When vibration acts on the fork main body F, the axle side tube 2 enters and exits The vehicle body side tube 1, and the fork main body F extends and contracts. Note that in the present embodiment, the fork main body F is of an inverted type in which the axle side tube 2 is inserted into the vehicle body side tube 1, but may be of an upright type in which the vehicle body side tube 1 is inserted into the axle side tube 2

Subsequently, in FIG. 2, the annular cap 3 is attached to an upper end of the vehicle body side tube 1 which is a vehicle body side end of the fork main body F. Furthermore, in FIG. 1, a lower end of the axle side tube 2, which is a lower end of the fork main body F, is closed by a bracket B on the axle side. Moreover, a tubular gap formed in the portion in which the vehicle body side tube 1 and the axle side tube 2 overlap with each other is closed by an annular sealing member 20 attached to a lower end of the vehicle body side tube 1 and in sliding contact with an outer circumference of the axle side tube 2.

In this manner, the inside of the fork main body F is a closed space, and a damper D is accommodated in the fork main body F. The damper D includes the cylinder 4 accommodated in the axle side tube 2, a piston 21 slidably inserted into the cylinder 4, and the piston rod 5 having a lower end connected to the piston 21 and an upper end protruding outside the cylinder 4 and connected to the cap

Since the cap 3 is connected to the vehicle body side tube 1, the piston rod 5 is connected to the vehicle body side tube 1 via the cap 3. Moreover, the cylinder 4 is connected to the axle side tube 2. As described above, the damper ID is provided between the vehicle body side tube 1 and the axle side tube 2, and the piston rod 5 relatively moves in an axial direction with respect to the cylinder 4 to extend and contract as the fork main body F extends and contracts.

Furthermore, an annular head member 22 is attached to an upper end of the cylinder 4, and the piston rod 5 movably penetrates an inner side of the head member 22 in the axial direction. The head member 22 slidably supports the piston rod 5, and a suspension spring 23 formed by the coil spring is interposed between the head member 22 and the cap 3. The suspension spring 23 exerts resilient force for separating the vehicle body side tube 1 and the axle side tube 2 from each other to bias the fork main body F in an extending direction. Therefore, the front fork FF elastically supports a vehicle body when interposed between a front wheel of the straddle vehicle and the vehicle body.

Furthermore, in the present embodiment, the piston rod 5 includes a tubular piston holding rod 5a connected to the piston 21, a tubular connector accommodation rod 5b connected to a lower end of the cap 3, and a tubular connection member 5c connecting the piston holding rod 5a and the connector accommodation rod 5b. Then, the connector accommodation rod 5b has a diameter larger than that of the piston holding rod 5a, and the thick tubular connection member 5c is inserted into an inner circumference of a lower end of the connector accommodation rod 5b and screwed. Furthermore, the piston holding rod 5a is inserted into an inner circumference of a lower end of the connection member 5c and screwed. Therefore, the piston rod 5 has a tubular shape and has a shape in which the upper end side is thicker in FIG. 1.

Note that the damper D according to the present embodiment is of a single rod type, and the piston rod 5 extends outside the cylinder 4 from one side of the piston 21. However, the damper D may also be of a double rod type, and piston rods may extend outside the cylinder from opposite sides of the piston. Furthermore, the suspension spring 23 may also be a spring other than the coil spring, such as an air spring.

Next, a liquid chamber L filled with a liquid such as a hydraulic oil is formed in the cylinder 4, and the liquid chamber L is partitioned into an extension side chamber R1 and a compression side chamber R2 by the piston 21. The extension side chamber here is a chamber that is compressed by the piston 21 when the damper D extends, among the two chambers partitioned by the piston. On the other hand, the compression side chamber is a chamber that is compressed by the piston 21 when the damper D contracts, among the two chambers partitioned by the piston 21.

Furthermore, a space outside the cylinder 4, more specifically, a space between the damper D and the fork main body F, is a liquid storage chamber R. In the liquid storage chamber R, the same liquid as the liquid in the cylinder 4 is stored, and a gas chamber G filled with a gas such as air is formed above a liquid level. In this manner, the fork main body F functions as an outer shell of a tank that stores a liquid separately from the liquid in the cylinder 4.

Note that although not illustrated, the liquid storage chamber R communicates with the compression side chamber R2, and a damping valve that gives resistance to a flow of the liquid flowing from the compression side chamber R2 toward the liquid storage chamber and a check valve that allows only a flow of the liquid flowing from the liquid storage chamber R toward The compression side chamber R2 are provided.

Furthermore, the piston 21 is provided with a damping passage 21a that interconnects the extension side chamber R1 and the compression side chamber R2, and a solenoid valve SV that gives resistance to a flow of the liquid passing through the damping passage 21a. The solenoid valve SV includes the solenoid S as an electric device and a valve body V driven by the solenoid S, and the resistance given to the flow of the liquid passing through the damping passage 21a can be adjusted in accordance with an amount of current to the solenoid S. The solenoid valve SV may be a variable relief valve capable of adjusting a valve opening pressure, or may be a spool valve capable of adjusting an opening degree of the damping passage 21a. Note that the damping passage 21a may be provided with an orifice or a damping valve in series or in parallel with the solenoid valve SV.

The solenoid S as an electric device in the solenoid valve SV is configured to receive power supply from an external power supply (not illustrated) through the wiring 7 accommodated in the piston rod 5. The wiring 7 connects the terminal 6 held by the cap 3 and the solenoid S as an electric device, and the connector C is provided partway. More specifically, the wiring 7 includes a device side wiring 7a having one end connected to the solenoid S and the other end connected to a plug 10 in the connector C, and a terminal side wiring 7b having one end connected to the terminal 6 and the other end connected to a receptacle 11 in the connector C. The connector C includes the plug 10 including a pin (not illustrated) electrically connected to the solenoid S via the device side wiring 7a therein, and the receptacle 11 including a contact electrically connected to the terminal 6 via the terminal side wiring 7b therein. Then, in the connector C, when the plug 10 is inserted into the receptacle 11, the pin is maintained in a state of being inserted into the contact to electrically connect the terminal 6 with the solenoid S, and when the plug 10 is removed from the receptacle 11, the contacting between the pin and the contact is cut to electrically disconnect the terminal 6 and the solenoid S. Note that the device side wiring 7a may be connected to the plug 10, and the terminal side wiring 7b may be connected to the receptacle 11.

The maximum width of the connector C is smaller than the inner diameter of the connector accommodation rod 5b of the piston rod 5, and the connector C can be accommodated in the connector accommodation rod 5b and can be taken in and out of the connector accommodation rod 5b from above the connector accommodation rod 5b. Furthermore, the device side wiring 7a has an extra length so that the connector C can be taken out from an upper end of the vehicle body side tube 1, and is accommodated in the connector accommodation rod 5b in a loosened state in a case where the connector C is in the connector accommodation rod 5b.

When the fork main body F extends and the damper D extends, the piston 21 moves upward with respect to the cylinder 4 in FIG. 1, a space of the extension side chamber R1 is reduced and a space of the compression side chamber R2 is enlarged, and the liquid in the compressed extension side chamber R1 passes through the damping passage 21a of the piston 21 and moves to the enlarged compression side chamber R2. Since the solenoid valve SV gives resistance to the flow of the liquid, the pressure in the extension side chamber R1 increases, and the damper D generates the damping force that hinders the extension of the fork main body F. Note that at the time of the extension of the damper D, the piston rod 5 is retracted from the inside of the cylinder 4, and an amount of the liquid as the piston rod 5 is retracted is insufficient in the cylinder 4. Therefore, the insufficient amount of The liquid is supplied into the cylinder 4 from the liquid storage chamber R through the check valve.

Conversely, when the fork main body F contracts and the damper C contracts, the piston 21 moves downward with respect to the cylinder 4 in FIG. 1, a space of the compression side chamber R2 is reduced and a space of the extension side chamber R1 is enlarged, and the liquid in the compressed compression side chamber R2 passes through the damping passage 21a of the piston 21 and moves to the enlarged extension side chamber R1. Furthermore, at the time of the contraction of the damper D, the piston rod 5 enters the cylinder 4, and an amount of the liquid as the piston rod 5 enters is excessive in the cylinder 4. Therefore, the excessive amount of the liquid is discharged to the liquid storage chamber R from the compression side chamber R2 through the damping valve. Since the solenoid valve SV gives resistance to the flow of the liquid toward the extension side chamber R1, and the damping valve gives resistance to the flow of the liquid toward the liquid storage chamber R, the pressure in the compression side chamber R2 increases, and the damper D generates the damping force that hinders the contraction of the fork main body F.

Here, since the solenoid valve SV can adjust the resistance given to the flow of the liquid by adjusting a current supplied to the solenoid S in solenoid valve SV, in the front fork FF according to the present embodiment, the damping force generated by the damper D can be adjusted both at the time of the extension and at the time of the contraction.

Subsequently, the cap 3 has a tubular shape, and includes a socket accommodation cylinder 31 which is inserted into the inner circumference of the upper end of the vehicle body side tube 1 to be screwed, and a rod connection cylinder 32 which is connected to a lower end of the socket accommodation cylinder 31 to be screwed to the outer circumference of an upper end of the connector accommodation rod 5b of the piston rod 5.

As illustrated in FIGS. 1 and 2, the socket accommodation cylinder 31 includes an annular bottom portion 31a connected to an upper end of the rod connection cylinder 32, a tubular portion 31b rising from the outer circumference of the bottom portion 31a and having outer and inner diameters larger than those of the rod connection cylinder 32, a screw portion 31c provided on the outer circumference of the tubular portion 31b and screwed to a screw portion 1a provided on the inner circumference of an upper end of the vehicle body side tube 1, an annular groove 31d provided on the inner circumference of the tubular portion 31b in a circumferential direction, two key grooves 31e provided on the inner circumference of an opening end of the tubular portion 31b at equal intervals in the circumferential direction, and a seal ring 31f attached to the inner side of the tubular portion 31b and on the inner side of the fork main body F below the groove 31d in FIG. 2. In other words, the key grooves 31e are provided on the inner circumference of the socket accommodation cylinder 31 with a phase difference of 180 degrees.

On the other hand, the rod connection cylinder 32 includes a screw portion 32a that is suspended from the inner circumference of the bottom portion 31a of the socket accommodation cylinder 31, extends downward, and is screwed to a screw portion 5d provided on the outer circumference of the connector accommodation rod 5b on the inner circumference.

As described above, the narrowest portion on the inner circumference of the cap 3 is the smallest portion of the inner diameter of the rod connection cylinder 32, but the inner diameter of this portion is larger than the inner diameter of the connector accommodation rod 5b. Therefore, the connector C can pass through the inner circumference of the cap 3 in any of the upper direction and the lower direction.

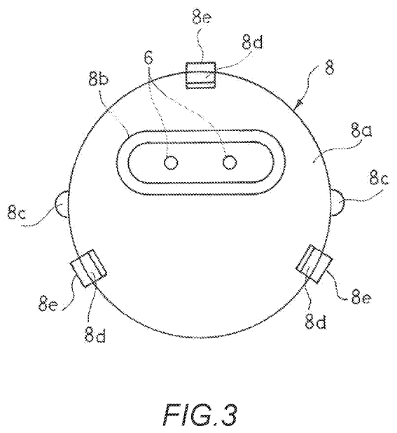

A socket 8 accommodating the terminal 6 therein is inserted into the inner circumference of the socket accommodation cylinder 31. As illustrated in FIGS. 1 to 3, the socket 8 includes a base portion 8a fitted to the inner circumference of the socket accommodation cylinder 31, and an annular socket portion 8b provided above the base portion 8a to accommodate the terminal 6 therein and allows fitting of a plug (not illustrated) connected to an external power supply. Furthermore, on the outer circumference of the base portion 8a, two keys 8c fitted into the key grooves 31e provided on the inner circumference of the socket accommodation cylinder 31 are provided at equal intervals in the circumferential direction, and three arms 8d rising from a lower side of the outer circumference of the base portion 8a are provided. Each of the arms 8d can be bent toward a center side of the base portion 8a, and includes a claw 8e protruding toward the outer circumferential side of the base portion 8a. Note that the socket portion 8b is provided not at the center of the base portion 8a but at an eccentric position. In other words, the keys 8c are provided on the outer circumference of the base portion 8a with a phase difference of 180 degrees.

The socket 8 is formed of a synthetic resin, and holds the terminal 6 connected to the terminal side wiring 7b at the socket portion 8b. The socket portion 8b surrounds the circumference of the terminal 6, and can be fitted with a plug (not illustrated) attached to a distal end of the wiring on the external power supply side. For example, the socket 8 configured in this manner is manufactured as follows. The terminal 6 connected to the terminal side wiring 7b is inserted into a mold for molding the socket portion 8b in advance, and a molding resin formed of a synthetic resin is injected into the mold to obtain the socket portion 8b by performing insert molding for integrating the terminal 6, the terminal side wiring 7b, and the socket portion 8b. Then, the socket portion 8b obtained by assembling the terminal 6 and the terminal side wiring 7b is inserted into a mold for molding the base portion 8a, and a molding resin formed of a synthetic resin is injected into the mold to obtain the socket 8 by performing insert molding for integrating the assembled socket portion 8b and the base portion 8a. Since the insert molding is performed twice, even when the socket portion 8b has a different shape of a portion to which the plug is fitted, the socket portion 8b can be integrated with the base portion 8a by using one mold. Therefore, even in a case where the socket portion 8b having the terminal 6 is purchased from the outside, the socket 8 can be obtained by integrating the socket portion 8b and the base portion 8a. Note that in order to obtain the socket portion 8b, only the terminal 6 may be inserted to integrate the terminal 6 and the socket portion 8b, and then the terminal side wiring 7b may be attached to the terminal 6.

In the socket 8 configured in this manner, when the base portion 8a is inserted into the socket accommodation cylinder 31 until the claw 8e faces the groove 31d, the claw 8e enters the groove 31d and is caught by the socket accommodation cylinder 31 to be held by the cap 3. Note that in a case where the socket 8 is removed from the cap 3, the claw 8e is retracted from the inside of the groove 31d when the arm 8d is bent toward the base portion 8a side. Therefore, the socket 8 is lifted upward while this state is maintained. In this way, since the claw 8e and the cap 3 are disengaged, the socket 8 is easily pulled out from the cap 3. A plurality of the claws 8e are provided on the socket 8, and the socket 8 cannot be pulled out from the cap 3 unless all the arms 8d are simultaneously bent. Therefore, there is no concern that the socket 8 accidentally falls off the cap 3 due to interference of tools or the like. In a structure in which the claw Be protrudes to the groove 31d and is fixed to the socket 8 and the cap 3 as described above, there is no operation of rotating the socket 8 with respect to the cap 3 when the socket 8 is attached to or removed from the cap 3. Therefore, there is not possibility that the wiring 7 is twisted when the socket 8 is attached to or removed from the cap 3. Therefore, disconnection and fatigue of the wiring 7 can be prevented.

Furthermore, when the socket 8 is attached to the cap 3 as described above, each of the keys 8c enter each of the corresponding key grooves 31e, and the rotation of the socket 8 in the circumferential direction with respect to the cap 3 is restricted. As described above, the key 8c and the key groove 31e function as a rotation stopper that prevents the rotation in the circumferential direction while allowing the relative movement between the socket 8 and the cap 3 in the axial direction, and prevents the rotation of the socket 8 in the circumferential direction to prevent twisting of the wiring 7 and prevent disconnection and fatigue of the wiring 7. Note that since the two keys 8c and the two key grooves 31e are provided in the socket 8 and the cap 3 respectively at equal intervals in the circumferential direction, the socket 8 can be fixed to the cap 3 in two attachment orientations. Furthermore, since the socket portion 8b is provided at a position eccentric from the center of the base portion 8a, the socket portion 8b can be disposed at any desired portion of two different positions with respect to the cap 3. The front fork FF is attached. to the vehicle body via an upper bracket, but a handle is attached to the upper bracket, and shapes of the upper bracket and handle and an attachment structure of the upper bracket and handle are different depending on a vehicle type. In this manner, since the position of the socket portion 8b of the socket 8 can be appropriately changed, the plug on the external power supply side can be reliably connected to the socket portion 8b while avoiding interference between the socket portion 8b and the handle regardless of the type of straddle vehicle. Note that in a case where three keys 8c and three key grooves 31e are provided in the socket 8 and the cap 3 respectively at equal intervals in the circumferential direction, the socket 8 can be fixed to the cap 3 in three attachment orientations, and when the number of the installed keys 8c and the number of the installed key grooves 31e are increased, variations in the position of the socket portion 8b increase accordingly. Furthermore, since the groove 31d into which the claw 8e is inserted is an annular groove, the claw 8e can be fitted into the groove 31d even when the socket 8 is attached to the cap 3 in the circumferential direction in any attachment orientation, and the socket 8 can be fixed to the cap 3. Note that in a case where the groove 31d is not the annular groove, the claws 8e and the groove 31d is only required to be provided such that all the claws 8e always face the groove 31d even when the attachment orientation of the socket 8 is changed.

Note that the socket 8 may be fixed to the cap 3 with other known fixing structures, for example, by using a screw that penetrates the socket 8 and is screwed to the bottom portion 31a of the socket accommodation cylinder 31 instead of the claw 8e and the groove 31d, or by providing a stopper on the inner circumference of the cap 3 and pinching the socket 8 between a nut screwed to the cap 3 and the stopper. Furthermore, the socket 8 may be fixed to the cap 3 by tension force of the seal ring 31f instead of the claw 8e and the groove 31d. In a case where the socket 8 is fixed by using the screw, since sealing a portion around the screw is additionally required, and a hole through which the screw passes is provided in the socket 8, the diameter of the base portion 8a of the socket 8 is increased, the outer diameter of the front fork FF is increased, and the number of components is increased. However, in a case where the socket 8 is fixed by the claw 8e and the groove 31d, or the seal ring 31f, there are advantages that the front fork FF is not increased in size and the number of the components is not increased.

The front fork FF is configured as described above, and in a case where maintenance work is performed, disassembly work is performed as follows. First, the arm 8d is bent toward the base portion 8a side to pull out the socket 8 from the cap 3, and the connector C is pulled out from the fork main body F through the inner circumference of the cap 3. Subsequently, the plug 10 of the connector C is removed from the receptacle 11, the device side wiring 7a and the terminal side wiring 7b are disconnected, and the socket 8 is completely removed from the fork main body F together with the device side wiring 7a. In this manner, the cap 3 can be completely removed from the vehicle body side tube 1 without interference of the wiring 7. When the cap 3 is removed from the vehicle body side tube 1, the disassembly work is completed, and the upper end opening portion of the vehicle body side tube 1 is completely opened such that maintenance work such as replacement of the suspension spring 23 and the seal in the fork main body F, and replacement or supply of the hydraulic oil in the damper D and the liquid storage chamber R can be performed.

In a case where the cap 3 and the socket 8 are attached to the fork main body F after the completion of the maintenance, the device side wiring 7a and the terminal side wiring 7b are connected by the connector C in a state in which the connector C and the cap 3 are separated. Subsequently, the cap 3 is attached to the vehicle body side tube 1, and then the socket 8 is attached to the cap 3. In the front fork FF of the present embodiment, since the cap 3 can be attached and detached as described above, the cap 3 can be completely separated from the fork main body F, and there is no possibility of twisting the wiring 7 when the cap 3 is attached and detached, and disconnection and fatigue of the wiring 7 can be prevented.

Note that in the present embodiment, the socket 8 holding the terminal 6 can be removed from the cap 3. However, even in a case where the terminal 6 is directly attached to the cap 3, when the cap 3 is removed from the vehicle body side tube 1 and the plug 10 of the connector C is removed from the receptacle 11, a wiring 7a does not hinder the complete removal of the cap 3 from the vehicle body side tube 1. That is, as described above, the terminal 6 may be directly attached to the cap 3, or may be indirectly attached to the cap 3 by being held by the socket 8 detachable from the cap 3.

As described above, the front fork FF according to the embodiment includes: the telescopic fork main body F that includes the vehicle body side tube 1 and the axle side tube 2, and is capable of extending and contracting; the cap 3 that is attached to the vehicle body side end of the vehicle body side tube 1; the cylinder 4 that is provided in the axle side tube 2; the tubular piston rod (rod) 5 that is inserted into the cylinder 4 so as to be axially movable and has one end connected to the cap 3; the solenoid (electric device) S that is accommodated in the cylinder 4; the terminal 6 that is provided in the cap 3; and the connector C that is provided partway in the wiring 7 connected to the terminal 6 and the solenoid (electric device) S and capable of electrically connecting and disconnecting the terminal 6 and the solenoid (electric device) S, and thus the terminal 6 and the solenoid (electric device) S are separated from partway, in the wiring 7 by the connector C, and the cap 3 can be easily and completely removed from the vehicle body side tube 1 to open the upper end opening portion of the vehicle body side tube 1 without being hindered by the wiring 7. Therefore, in the front fork FF of the present embodiment, maintenance work is easily performed even when the solenoid (electric device) S is provided therein.

Furthermore, in the front fork of the present embodiment, the cap 3 has an annular shape and includes the socket 8 that is detachably attached to the inner circumference of the cap 3 and holds the terminal 6, and the connector C can pass through the inner circumference of the cap 3. In the front fork FF configured in this manner, as described above, the socket 8 is removed from the cap 3 without removing the cap 3 from the, vehicle body side tube 1, the connector C is taken out from the fork main body F, the connector C is separated, and thus the wiring 7 can be separated into the device side wiring 7a and the terminal side wiring7b. Furthermore, in the front fork FF of the present embodiment, since the wiring 7 can be separated into the device side wiring 7a and the terminal side wiring 7b without twisting the wiring 7, disconnection and deterioration of the wiring 7 can be suppressed. Moreover, since the socket 8 and the terminal side wiring 7b can be removed from the cap 3, the work of removing the cap 3 from the vehicle body side tube 1 is also easily performed.

Moreover, in the front fork FF according to the present embodiment, the cap 3 has an annular shape, and includes the socket 8 that is detachably attached to the inner circumference of the cap 3 and holds the terminal 6, the connector C can pass through the inner circumference of the cap 3, the socket 8 includes the base portion 8a inserted into the inner circumference of the cap 3, and the base portion 8a includes the claw 8e that can be inserted into the groove 31d formed in the inner circumference of the cap 3. In the front fork FF configured in this manner, an operation of rotating the socket 8 with respect to the cap 3 is not performed in the attachment and detachment work of the socket 8 with respect to the cap 3, and the wiring 7 is not twisted. Therefore, disconnection and fatigue of the wiring 7 can be prevented. Furthermore, since the socket 8 and the cap 3 are not increased in size as compared with the case where the socket 8 is fixed to the cap 3 by the screw, it is possible to prevent the front fork FF from being increased in size.

The front fork FF according to the present embodiment includes a rotation stopper that prevents the rotation in the circumferential direction while allowing the relative movement between the socket 8 and the cap 3 in the axial direction. In the front fork FF configured in this manner, since the socket 8 does not rotate in the circumferential direction with respect to the cap 3 and does not twist the wiring 7, disconnection and deterioration of the wiring 7 can be prevented when the front fork FF is used. Note that the rotation stopper allows an axial movement of the socket 8 with respect to the cap 3, and thus does not hinder the attachment and detachment of the socket 8 with respect to the cap 3. Furthermore, the seal ring 31f may be used as a rotation stopper by giving a tension force restricting the movement of the socket 8 in the circumferential direction with respect to the cap 3 to the seal ring 31f provided in the cap 3, and the seal ring may be provided on the outer circumference of the base portion 8a of the socket 8 instead of the cap 3 side.

Furthermore, the rotation stopper includes the key 8c that is provided on the outer circumference of the socket 8 and the key groove 31e that is provided on the inner circumference of the cap 3 and into which the key 8c is inserted, and the rotation stopper is installed at two places at equal intervals in the circumferential direction of the socket 8 and the cap 3. In the front fork FF configured in this manner, the socket 8 can be attached to the cap 3 in two different attachment orientations in the circumferential direction. Therefore, in the front fork FF of the present embodiment, since the position of the socket portion 8b can be changed, the plug on the external power supply side can be reliably connected to the socket portion 8b while avoiding interference between the socket portion 8b and the handle regardless of the type of straddle vehicle. Note that the rotation stopper including the key 8c and the key groove 31e may be installed at three places at equal intervals in the circumferential direction of the socket 8 and the cap 3. In this case, the socket 8 can be attached to the cap 3 in two different attachment orientations in the circumferential direction. Furthermore, the key may be provided on the inner circumference of the cap 3, and the key groove may be provided on the outer circumference of the socket.

Note that in the front fork FF of the present. embodiment, the piston rod 5 includes the tubular piston holding rod 5a connected to the piston 21, and the tubular connector accommodation rod 5b connected to the lower end of the cap 3, and the connector accommodation rod 5b has the diameter larger than that of the piston holding rod 5a. In the front fork FF of the present embodiment, the connector C bulkier than that of the wiring 7 is accommodated in the connector accommodation rod 5b having a large diameter, and only the piston holding rod 5a having a small diameter is inserted into the cylinder 4 of the damper D. In the front fork FF configured in this manner, since the bulky connector C is accommodated in the connector accommodation rod 5b outside the cylinder 4 and only the piston holding rod 5a having a small outer diameter is inserted into the cylinder 4, a pressure receiving area of the piston 21 can be secured without increasing the diameter of the cylinder 4, and extension side damping force can be sufficiently exerted while avoiding an increase in size of the front fork FF.

Note that in the front fork FF of the present embodiment, the electric device is the solenoid S, but the electric device is not limited to the solenoid S, and the electric device may be a coil in a case where the damper D is a damper using electroviscous fluid or magnetic viscous fluid and the coil is used to change viscosity. Furthermore, the electric device may be a sensor or the like for detecting the pressure in the damper D or detecting the extension/contraction displacement of the fork main body F in addition to the electric device used for adjusting the damping force of the damper D in the front fork FF. That is, the present invention can be applied to the front fork FF in which the electric device is accommodated the cylinder 4. Note that as long as at least a part of the electric device is inserted into the cylinder 4 even when the electric device is displaced with respect to the cylinder 4, this meets the definition that the electric device is accommodated in the cylinder 4.

Although the preferred embodiments of the present invention have been described above in detail, modifications, variations, and changes are possible without departing from the scope of the claims.

This application claims priority under Japanese Patent Application No. 2019-143773 filed with the Japan Patent Office on Aug. 5, 2019, the entire contents of which are incorporated herein by reference.

### REFERENCE SIGNS LIST

1 Vehicle body side tube
2 Axle side tube
3 Cap
4 Cylinder
5 Piston rod (rod)
6 Terminal
7 Wiring
8 Socket
8a Base portion
8c Key
8e Claw
31e Key groove
C Connector
F Fork main body
S Solenoid (electric device)

1. A front fork comprising:
a telescopic fork main body that includes a vehicle body side tube and an axle side tube and is capable of extending and contracting;
a cap that is attached to a vehicle body side end of the vehicle body side tube;
a cylinder that is provided in the axle side tube;
a tubular rod that is inserted into the cylinder so as to be axially movable and has one end connected to the cap;
an electric device that is accommodated in the cylinder;
a terminal that is provided in the cap; and
a connector that is provided partway in a wiring connected to the terminal and the electric device and capable of electrically connecting and disconnecting the terminal and the electric device.

2. The front fork according to claim 1, wherein
the cap has an annular shape and includes the socket that is detachably attached to an inner circumference of the cap and holds the terminal, and
the connector is capable of passing through the inner circumference of the cap.

3. The front fork according to claim 2, wherein
the socket includes a base portion inserted into the inner circumference of the cap, and
the base portion includes a claw that is capable of being inserted into a groove formed in the inner circumference of the cap.

4. The front fork according to claim 2, further comprising a rotation stopper that prevents a rotation in a circumferential direction while allowing a relative movement between the socket and the cap in an axial direction.

5. The front fork according to claim 2, wherein
the rotation stopper includes a key that is provided on one of an outer circumference of the socket and the inner circumference of the cap and a key groove that is provided on the other one of the outer circumference of the socket and the inner circumference of the cap and into which the key is inserted, and
the rotation stopper is installed at two or three places at equal intervals in the circumferential direction of the socket and the cap.
